(19) United States
(12) Patent Application Publication
(10) Pub. No.: US 2026/0320860 A1
(43) Pub. Date: Oct. 15, 2026

(54) HYPERNETWORKS FOR CONTENT RECONTEXTUALIZATION

(71) Applicant: eBay Inc., San Jose, CA (US)

(72) Inventors: Jakub Adam BALICKI, Wroclaw (PL); Oriol CAUDEVILLA TORRAS, Seattle, WA (US); Tomasz DROZDZ, Wroclaw (PL); Konrad KARANOWSKI, Wroclaw (PL); Pawel LOREK, Trzebnica (PL); Hong LYU, Bellevue, WA (US); Aleksander Piotr SKORUPA, Wroclaw (PL); Jakub Mikolaj TOMCZAK, Diemen (NL); Tomaz TRZCINSKI, Warszawa (PL); Maciej ZIEBA, Wroclaw (PL)

(21) Appl. No.: 19/174,049

(22) Filed: Apr. 9, 2025

(51) Int. Cl. G06T 11/60; G06F 40/40; G06V 10/774; G06V 10/776; G06V 10/82

(52) U.S. Cl. CPC G06T 11/60; G06F 40/40; G06V 10/774; G06V 10/776; G06V 10/82

(57) ABSTRACT

Some aspects relate to technologies for content recontextualization using hypernetworks to generate Low-Rank Adaptation (LoRA) parameters for adapting a generative model. In some aspects, content recontextualization involves accessing a content item and recontextualization text, generating LoRA parameters by processing the content item with a hypernetwork model, and creating a prompt from the recontextualization text. The generative model, adapted with the LoRA parameters provided by the hypernetwork model, then generates a recontextualized content item based on the prompt. The hypernetwork model can be trained using a dataset of training samples, where each sample comprises a training content item as training input and a target recontextualized item as ground truth. Each training sample can also include a training prompt or training recontextualization text. The hypernetwork model is trained using the training samples by iteratively updating parameters of hypernetworks in the hypernetwork model, while keeping parameters of the generative model frozen.

### BACKGROUND

Content recontextualization refers to the process of adapting or altering content to fit new contexts or purposes and is used in a variety of different fields, such as art, media, marketing, and e-commerce. This can involve changing the format, presentation, or even the message of the original content to make it more suitable or effective for different audiences, cultures, or situations. Content recontextualization can be performed for a variety of different content modalities, such as text, image, audio, and video. For instance, image recontextualization often involves placing an object from an input image into a new context to serve a specific purpose, such as placing an image of a clothing item on a model in a recontextualized image.

### SUMMARY

Some aspects of the present technology relate to, among other things, content recontextualization using hypernetworks to generate Low-Rank Adaptation (LoRA) parameters for adapting a generative model. In some aspects, an input content item and recontextualization text are received for recontextualizing the input content item. The input content item comprises content to be recontextualized, while the recontextualization text provides a textual description of a new context for recontextualization. The recontextualization process involves generating LoRA parameters using a hypernetwork model processing the input content item, and creating a prompt from the recontextualization text. A generative model, adapted with the LoRA parameters provided by the hypernetwork model, then generates a recontextualized content item based on the prompt.

The hypernetwork model can be trained using a dataset of training samples, where each training sample includes a training content item, a target recontextualized item, and either a training recontextualization text or a training prompt. Given a training sample from the dataset, an iteration of the training process involves causing the hypernetwork model to generate LoRA parameters using the training content item from the training sample. The generative model is adapted with the LoRA parameters, and the adapted generative model generates an output recontextualized item by processing a prompt (either a training prompt from the training sample or a prompt generated from recontextualization text from the training sample). A loss is determined as a function of the output recontextualized item and the target recontextualized item from the training sample, and the parameters of the hypernetwork model are updated based on the loss (e.g., via backpropagation). This iterative training process continues until the hypernetwork model is adequately trained to generate accurate LoRA parameters for content recontextualization.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating operation of model components for content recontextualization in accordance with some implementations of the present disclosure;

FIG. 3 is a block diagram illustrating an example operation for training a hypernetwork model in accordance with some implementations of the present disclosure;

FIG. 4 is a diagram illustrating another example operation for training a hypernetwork model in accordance with some implementations of the present disclosure;

FIG. 5 is a flow diagram showing an example method for content recontextualization using a generative model adapted with hypernetwork-generated LoRA parameters in accordance with some implementations of the present disclosure;

FIG. 6 is a flow diagram showing an example method for training a hypernetwork to generate LoRA parameters for adapting a generative model for content recontextualization in accordance with some implementations of the present disclosure; and

FIG. 7 is a block diagram of an exemplary computing environment suitable for use in implementations of the present disclosure.

### DETAILED DESCRIPTION

### Overview

Content recontextualization is a task that involves taking a content item from its original context and presenting it in a new or different setting to serve a new purpose. This problem is typically encountered in art, media, and communication, and it is relevant to marketing and e-commerce. For instance, image recontextualization can be used to recontextualize a photo of a purse captured by a seller in the context of a luxurious brand shopping window.

In recent years, the concept of content recontextualization has gained more momentum due to deep generative modeling. This is particularly true in the image recontextualization space using image-to-image and text-to-image synthesis models like diffusion models. An example of such an approach is the DreamBooth model, which fine-tunes a large pre-trained text-to-image diffusion model to enable personalization and subject recontextualization. This model takes a few images of a subject and then generates new images recontextualizing the subject in different environments, views, or poses while preserving key visual features. Another example is “Magic Clothing”, which provides a latent diffusion model for generating clothing-related images.

One challenge with content recontextualization using pre-trained models (e.g., image recontextualization with pre-trained diffusion models) is the necessity of fine-tuning. Fine-tuning of pre-trained models to specific tasks is a ubiquitous practice in machine learning, particularly in domains such as computer vision and natural language processing. It involves using training data to update parameters (e.g., weights) of the pre-trained models for the specific tasks.

Some existing methods for recontextualization, such as the DreamBooth model, require fine-tuning per single content item, which requires significant time and extensive prompting, while the results are often of low quality or do not match a given prompt. Other approaches to recontextualization, like Magic Clothing, require reorganization of the architecture of the base model and a time-consuming training process in a particular domain. Other techniques, such as IP Adapter, enhance base architectures with additional, trainable cross-attention layers to preserve contextual details during recontextualization. However, these layers do not integrate context image information with textual features.

Low-Rank Adaptation (LoRA) is a fine-turning technique that was initially used to adapt large language models (LLMs) but is now commonly used across different domains and model architectures. LoRA is designed to adapt pre-trained models more efficiently by updating only a small set of model parameters during training while keeping pre-trained weights frozen. In LoRA, a pre-trained model is adapted by applying changes (ΔWᵢ) to pre-trained weights (Wᵢ) of the model, where the adapted weights (

$$( {W}_{i}^{′} )$$

) are given by:

$${W}_{i}^{′} = {W}_{i} + Δ {W}_{i} .$$

More specifically, LoRA introduces trainable low-rank matrices (i.e., Aᵢ and Bᵢ) into the model's architecture. Namely, given a pre-trained matrix Wᵢ, LoRA injects two low-rank matrices to provide:

$${W}_{i}^{′} = {W}_{i} + Δ {W}_{i} = {W}_{i} + {B}_{i} {A}_{i} .$$

These low-rank matrices are referred to herein as LoRA parameters. During model training, the pre-trained weights (Wᵢ) of the model are frozen and only the low-rank matrices (Bᵢ, Aᵢ) are updated. This can be performed for any number of matrices at any number of layers of a model.

LoRA allows for significant updates to a pre-trained model's behavior with relatively few additional parameters, making it computationally efficient and well-suited for scenarios where deploying full-scale model training is not feasible. Despite its potential for improved performance, LoRA has drawbacks in its application to content recontextualization. In particular, when used for content recontextualization, LoRA requires fine-tuning models individually for each content item in order to provide LoRA parameters specific to each content item. Fine-tuning models on a per-item basis is not only computationally expensive but also requires significant time.

Aspects of the technology described herein provide an improved approach to content recontextualization that addresses the technical shortcomings of existing recontextualization approaches. In accordance with some aspects, a novel framework leverages hypernetworks to predict LoRA parameters for a pre-trained generative model, allowing for more efficient content recontextualization without the need for item-specific fine-tuning. The use of hypernetworks provides a single, shared neural network model for outputting weights for adapting a generative model for different content items. As a result, this eliminates the need for fine-tuning a model for individual content items, thereby significantly reducing computational costs and time requirements.

To perform recontextualization using a trained hypernetwork model, an input content item and recontextualization text are received. The input content item comprises content to be recontextualized, while the recontextualization text provides a textual description of a new context for recontextualization. The input content item is provided to the trained hypernetwork model, which outputs a set of LoRA parameters. Additionally, a prompt is generated from the recontextualization text. A generative model is adapted with the LoRA parameters from the hypernetwork model, and the adapted model is provided the prompt as input, causing the adapted model to generate a recontextualized content item.

The hypernetwork model can be trained using a dataset of training samples, where each training sample includes a training content item, a target recontextualized item, and either a training recontextualization text or a training prompt. Given a training sample from the dataset, an iteration of the training process involves causing the hypernetwork model to generate LoRA parameters using the training content item from the training sample. The generative model is adapted with the LoRA parameters, and the adapted generative model generates an output recontextualized item by processing a prompt (either a training prompt from the training sample or a prompt generated from recontextualization text from the training sample). A loss is determined as a function of the output recontextualized item and the target recontextualized item from the training sample, and the parameters of the hypernetwork model are updated based on the loss (e.g., via backpropagation). This iterative training process continues until the hypernetwork model is adequately trained to generate accurate LoRA parameters for content recontextualization.

Aspects of the technology described herein provide a number of improvements over existing recontextualization techniques. For instance, the technology enables instant adaptation of content to new contexts by a generative model without the need for fine-tuning, resulting in more efficient and scalable model deployment. This is achieved by effectively combining features from both text and other modalities (e.g., image) without requiring additional architectural designs or training in the base model. Additionally, the technology is not limited to image data but can be applied across multiple modalities, including text, videos, sound, and structured data (e.g., point clouds), providing a shared and unified representation for multiple contexts and content modalities. Unlike traditional methods that require fine-tuning per single content item and extensive prompting, this approach leverages hypernetworks to predict LoRA parameters, eliminating the need for fine-tuning models for individual content items and significantly reducing computational costs and time requirements. In the image recontextualization space, compared to methods like IP Adapter or Magic Clothing, some aspects described herein combine textual and image features in one attention mechanism and does not require any modifications or training of the base generative model. Experimental results have demonstrated its improved effectiveness for recontextualization relative to existing approaches.

### Example System for Content Recontextualization Using Hypernetworks

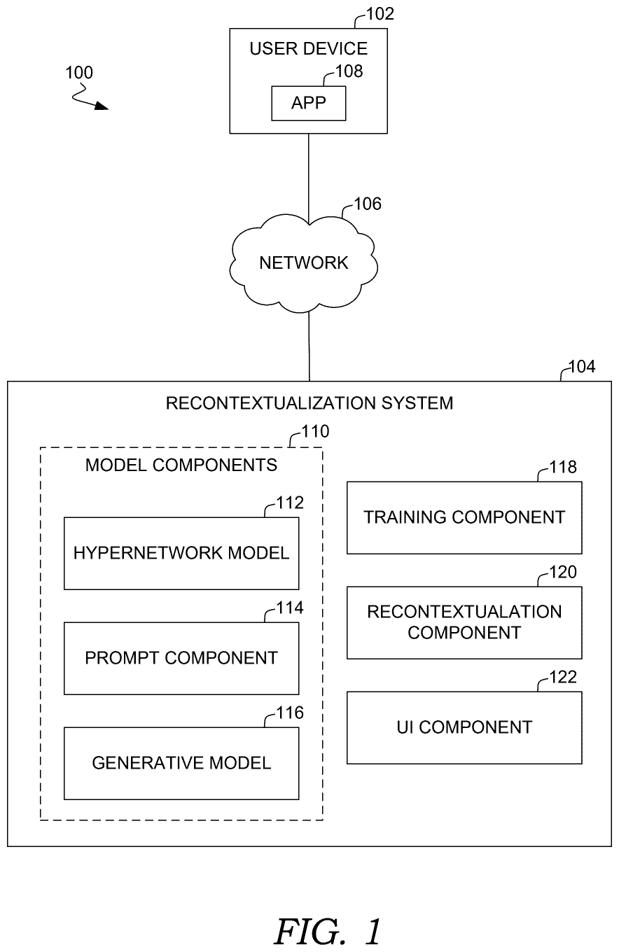

With reference now to the drawings, FIG. 1 is a block diagram illustrating an exemplary system 100 for content recontextualization using hypernetworks to generate LoRA parameters for model adaptation in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

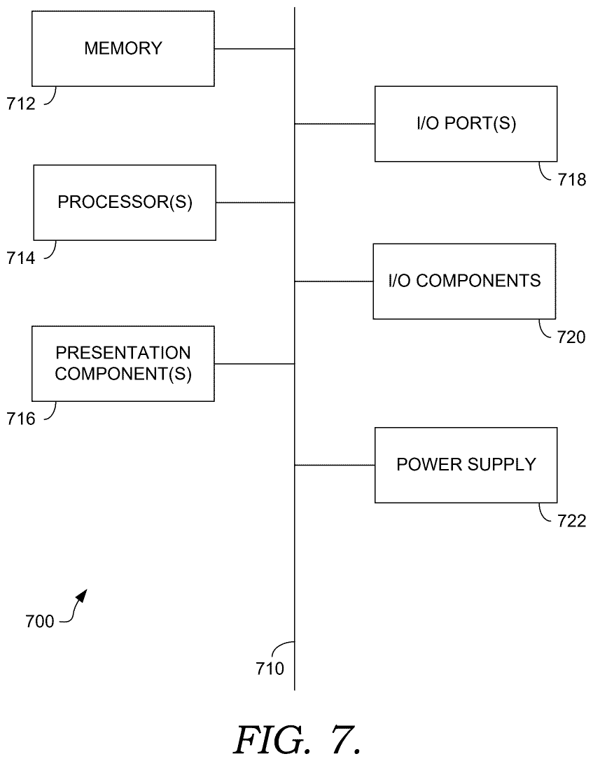

The system 100 is an example of a suitable architecture for implementing certain aspects of the present disclosure. Among other components not shown, the system 100 includes a user device 102 and a recontextualization system 104. Each of the user device 102 and the recontextualization system 104 shown in FIG. 1 can comprise one or more computer devices, such as the computing device 700 of FIG. 7, discussed below. As shown in FIG. 1, the user device 102 and the recontextualization system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the recontextualization system 104 could be provided by multiple server devices collectively providing the functionality of the recontextualization system 104 as described herein. Additionally, other components not shown may also be included within the network environment.

The user device 102 can be a client device on the client-side of the system 100, while the recontextualization system 104 can be on the server-side of the system 100. The recontextualization system 104 can comprise server-side software designed to work in conjunction with client-side software on the user device 102 so as to implement any combination of the features and functionalities discussed in the present disclosure. For instance, the user device 102 can include an application 108 for interacting with the recontextualization system 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the recontextualization system 104 remain as separate entities. While the system 100 illustrates a configuration in a networked environment with a separate user device and recontextualization system, it should be understood that other configurations can be employed in which aspects of the various components are combined. For instance, in some aspects, aspects of the recontextualization system 104 can be implemented in part or in whole by the user device 102.

The user device 102 can comprise any type of computing device capable of use by a user. For example, in one aspect, the user device 102 may be the type of computing device 700 described in relation to FIG. 7 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the recontextualization system 104 via the user device 102.

The recontextualization system 104 performs content recontextualization. As described in further detail below, the recontextualization system 104 trains a hypernetwork model 112 for generating LoRA parameters to adapt a generative model 116. After model training, the recontextualization system 104 generates recontextualized content items from input content items. In particular, given an input content item and recontextualization text describing an output context, the recontextualization system 104 recontextualizes the input content item to provide a recontextualized content item in the output context specified by the recontextualization text.

As shown in FIG. 1, the recontextualization system 104 includes model components 110 (including a hypernetwork model 112, a prompt component 114, and a generative model 116), a training component 118, a recontextualization component 120, and user interface component 122. The components of the recontextualization system 104 may be in addition to other components that provide further additional functions beyond the features described herein. The recontextualization system 104 can be implemented using one or more server devices, one or more platforms with corresponding application programming interfaces, cloud infrastructure, and the like. While the recontextualization system 104 is shown separate from the user device 102 in the configuration of FIG. 1, it should be understood that in other configurations, some or all of the functions of the recontextualization system 104 can be provided on the user device 102. Additionally, in some configurations, one or more of the components of the recontextualization system 104 shown in FIG. 1 can be provided by the user device 102 and/or another location not shown in FIG. 1. The components can be provided by a single entity or multiple entities.

In some aspects, the functions performed by components of the recontextualization system 104 are associated with one or more applications, services, or routines. In particular, such applications, services, or routines may operate on one or more user devices, servers, may be distributed across one or more user devices and servers, or be implemented in the cloud. Moreover, in some aspects, these components of the recontextualization system 104 may be distributed across a network, including one or more servers and client devices, in the cloud, and/or may reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed.

As shown in FIG. 1, the recontextualization system 104 includes a number of model components 110 for performing content recontextualization, including a hypernetwork model 112, a prompt component 114, and a generative model 116.

The hypernetwork model 112 takes a content item as input and generates LoRA parameters for the generative model 116 for content recontextualization. The hypernetwork model 112 comprises a number of hypernetworks that predict values of LoRA parameters. Each hypernetwork comprises an artificial neural network (ANN) model configured to predict the LoRA parameters for the generative model 116. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some aspects, the hypernetwork model 112 uses small-sized, parallel, shallow hypernetworks. Size of a hypernetwork is used herein to refer to the number of parameters (e.g., weights) in the hypernetwork. In some configurations, a small hypernetwork has no more than a few thousand parameters; while in other configurations, a small hypernetwork could have fewer than 100,000 parameters. Depth of a hypernetwork is used herein to refer to the number of layers in the hypernetwork. In some configurations, a shallow hypernetwork has no more than two hidden layers.

The hypernetwork model 112 can include a hypernetwork for each of a number of matrices at various layers of the generative model 116. The matrices for which LoRA parameters are generated by the hypernetwork model 112 can vary based on the generative model 116 and the modality of the content being recontextualized. For instance, in configurations in which the generative model 116 comprises a diffusion model, the hypernetwork model 112 could include a hypernetwork for each matrix of each cross-attention layer. In some embodiments, the hypernetwork model 112 also includes a content item encoder that encodes the input content item before operation of the hypernetworks.

The prompt component 114 takes a content item and recontextualization text as input and generates a prompt for input to the generative model 116 for content recontextualization. The recontextualization text comprises a textual description of a desired context for recontextualizing the input content item. The prompt component 114 includes a text generation model that generates a textual description of the input content item. The textual description can comprise a semantic description providing text that explains the meaning of the input content item.

The text generation model used by the prompt component 114 can generally comprise one or more ANN models. In some configurations, the text generation model can be a multi-modal model capable of handling multiple types of input and/or output modalities (e.g., text, image, audio, video, etc.). Different text generation models can be employed based on the modality of the content item being recontextualized. For instance, pre-trained text models can be used to process a text item and generate a description based on natural language processing; pre-trained image models can be used to generate textual descriptions of images, capturing the semantic content and context; pre-trained audio models can be used to transcribe audio into text and then generate a semantic description of the transcribed text; pre-trained video models can be used to analyze video frames and generate descriptive text that summarizes the content of the video. In some instances, the prompt component 114 can use a single ANN model as the text generation model for generating a textual description of an input content item; while in other instances, the prompt component 114 can use a combination of ANN models.

After generating the textual description of the input content item, the prompt component 114 generates a prompt using a combination of the input recontextualization text and the textual description of the input content item. For instance, a text merger could be used to merge the input recontextualization text with the textual description of the input content item to provide the prompt. In some configurations, the text merger can be, for instance, a pre-trained LLM. The prompt provides a description of the input content item in the new context provided by the recontextualization text.

The generative model 116 is adapted by LoRA parameters from the hypernetwork model 112, and the adapted model processes the prompt from the prompt component 114 to generate a recontextualized content item as output. The generative model 116 generally comprises a pre-trained ANN model. The type of ANN model used can vary based on the modality of the content being recontextualized. For instance, for text recontextualization, the generative model 116 can be a pre-trained LLM (e.g. using transformer models, recurrent neural network (RNN) models, etc.); for image recontextualization, the generative model 116 can be an image generation model (e.g., using diffusion models, latent diffusion models, etc.); for audio recontextualization, the generative model 116 can be an audio generation model (e.g., using transformer models, RNN models, etc.); for video recontextualization, the generative model 116 can be a video generation model (e.g., using diffusion models, latent diffusion models, etc.).

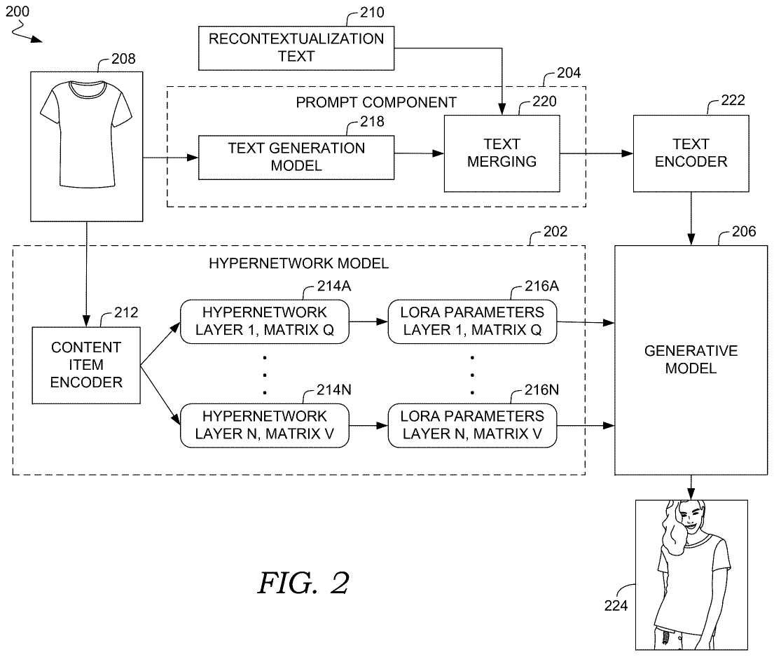

FIG. 2 provides a block diagram that illustrates operation 200 of model components for a recontextualization system in accordance with some aspects. The model components include: a hypernetwork model 202 (which can correspond to the hypernetwork model 112 of FIG. 1); a prompt component 204 (which can correspond to the prompt component 114 of FIG. 1); and a generative model 206 (which can correspond to the generative model 116 of FIG. 1).

The input includes both an input content item 208 and a recontextualization text 210. In this example, the input content item 208 comprises an image of a t-shirt. The recontextualization text 210 provides a description of the new context for recontextualization. For instance, in the example of FIG. 2 in which the input content item 208 comprises a t-shirt and the desired recontextualization is a female model wearing the t-shirt, the recontextualization text can be a human model description, such as “female, blond, 24 years.”

The input content item 208 is provided as input to the hypernetwork model 202, which generates LoRA parameters 216A-216N. As shown in FIG. 2, the input content item 208 is processed by a content item encoder 212 to generate a content item embedding of the input content item 208. In this example in which the input content item is an image, the content item encoder 212 comprises an image encoder. Other types of encoders can be employed for other content types.

The content item embedding from the content item encoder 212 is further transformed by hypernetworks 214A-214N (which can be small-sized, parallel, shallow hypernetworks), which predict values of LoRA parameters 216A-216N. In this example, the hypernetworks 214A-214N predict the values of matrices

$${A}_{i}^{j} and {B}_{i}^{j}$$

(LoRA parameters) for the i-th layer and the j-th matrix for layers of the generative model 206. For instance, in the case of a diffusion model, this could be each of the cross-attention matrices j∈{q, k, v, o} on each layer i ∈{1, . . . ,N} of the denoising network.

The input content item 208 and the recontextualization text are also provided as input to the prompt component 204, which generates a prompt for content recontextualization. As shown in FIG. 2, the input content item 208 is provided to a text generation model 218 to generate a textual description of the input content item 208. The prompt is then generated by text merging 220 the textual description of the input content item 208 with the recontextualization text 210. In some aspects, the text generation model 218 and the text merging 220 can be performed using a pre-trained LLM.

The LoRA parameters 216A-216N from the hypernetwork model 202 are used with the prompt from the prompt component 204 to generate a recontextualized image 224 using the generative model 206. In this example, the prompt is tokenized using a text encoder 222 to provide a text embedding as input to the generative model 206. The generative model 206 is adapted with the LoRA parameters and processes the tokenized prompt from the text encoder 222 to generate the recontextualized image 224. In this example, the recontextualized image 224 comprises an image in which a model (as described by the recontextualization text 210) is wearing the t-shirt from the input content item 208.

With reference again to FIG. 1, the training component 118 of the recontextualization system 104 trains the hypernetwork model 112 to generate LoRA parameters for recontextualization. During training, in some aspects, parameters of the hypernetwork model 112 are updated, while parameters of other models are frozen (i.e., models used by the prompt component 114 and the generative model 116).

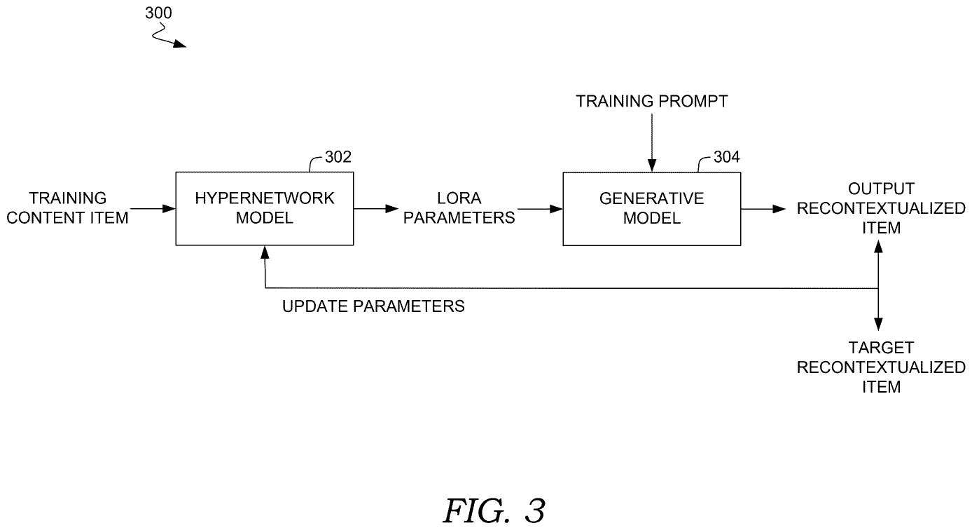

The training component 118 employs a training dataset having a number of training samples to train the hypernetwork model 112. In some configurations, each training sample comprises a training content item, a target recontextualized item, and a training prompt. FIG. 3 provides a block diagram showing an example operation 300 for training a hypernetwork model 302 using such a training sample. As shown in FIG. 3, the training content item from the training sample is provided as input to the hypernetwork model 302, which outputs a set of LoRA parameters. The generative model 304 is adapted by the LoRA parameters, and the training prompt from the training sample is provided to the adapted model, which generates an output recontextualized item. A loss is determined as a function of the output recontextualized item and the target recontextualized item, and parameters of the hypernetwork model 302 are updated based on the loss (e.g., via backpropagation). In some aspects, this includes updating parameters of a content item encoder and each hypernetwork of the hypernetwork model 302, while keeping the parameters of the generative model 304 frozen.

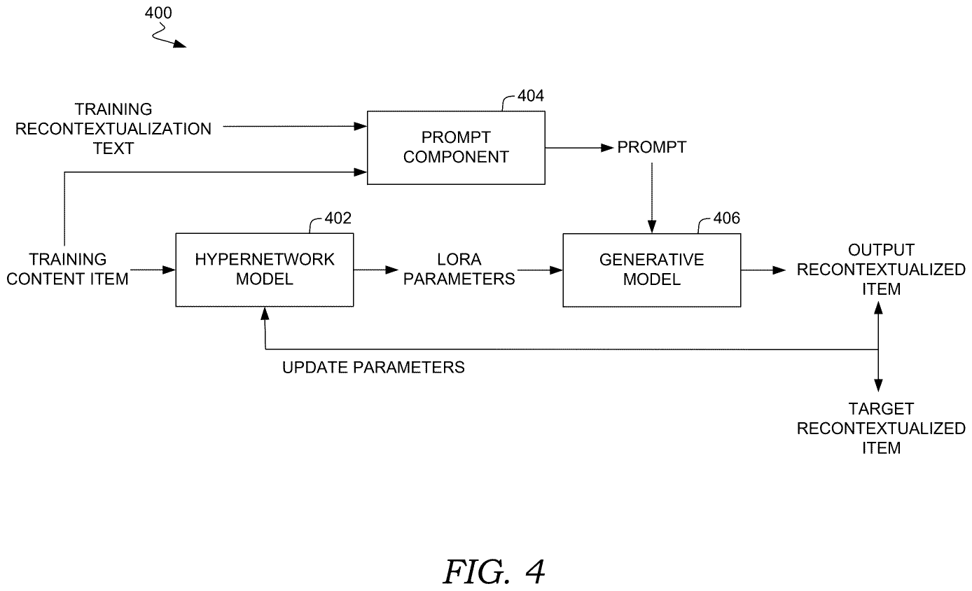

In other configurations, each training sample comprises a training content item, a target recontextualized item, and training recontextualization text. FIG. 4 provides a block diagram showing an example operation 400 for training a hypernetwork model 402 using such a training sample. As shown in FIG. 4, the training content item from the training sample is provided as input to the hypernetwork model 402, which outputs a set of LoRA parameters. The training content item and the training recontextualization text from the training sample are also provided to a prompt component 404, which outputs a prompt. The generative model 406 is adapted by the LoRA parameters, and the prompt from the prompt component 404 is provided to the adapted model, which generates an output recontextualized item. A loss is determined as a function of the output recontextualized item and the target recontextualized item, and parameters of the hypernetwork model 402 are updated based on the loss (e.g., via backpropagation). In some aspects, this includes updating parameters of a content item encoder and each hypernetwork of the hypernetwork model 302, while keeping the parameters of the prompt component 404 and the generative model 406 frozen.

In further aspects, the training component 118 can train the hypernetwork model 112 in multiples stages using different types of training samples. For instance, the training component 118 could use a two-stage training approach. At a first stage, the training component 118 can train the hypernetwork model by performing the operation 300 using training samples having training prompts. In a subsequent stage, the training component 118 can train the hypernetwork by performing the operation 400 using training samples having training recontextualized text instead of training prompts.

By way of example only and not limitation, given a training dataset Dₜᵣₐᵢₙ in which each training sample is a triple (x^{c}, x^{tg}, y^{t}), where x^{c} is a training content item, x^{tg} is a corresponding target recontextualized item, and y^{t} is a corresponding training prompt, the training component 118 can train parameters (φ) of the hypernetwork model 112 ( [symbol] _{φ}(·)) by minimizing the following loss function:

$$L = {𝔼}_{( {x}^{c} , {x}_{0}^{tg} , {y}^{t} ) ∼ 𝒟 , {z}_{0}^{tg} = ε ( {x}_{0}^{tg} ) , t ∼ Unif ( \{ 1 , 2 , … , T \} ) , ε ∼ 𝒩 ( 0 , I )} {‖ ε - {ε}_{θ} ‖}_{2}^{2}$$

$$where {ε}_{θ} ≡ {ε}_{θ} ( {z}_{t}^{tg} , t , {τ}_{θ} ( {y}^{t} ) , {ℋ}_{ϕ} ( {x}^{c} ) ) ,$$

and [symbol] _{φ}(x^{c}) provides the LoRA parameters to the denoising model ϵ_{θ}.

Moreover, to emulate the zero-value condition for initialization of

$${B}_{i}^{j}$$

matrices

$$( {B}_{i}^{j} = 0 ) ,$$

some aspects incorporate an additional, trainable scaling parameter γ (which can be the same for all matrices, initially close to 0) to scale the matrices' values, providing:

$$Δ {W}_{i}^{j} = γ {B}_{i}^{j} {A}_{i}^{j}$$

Thus, in some configurations, the trainable parameters of the hypernetwork model 112 are the content item encoder, the hypernetworks (each predicting values of matrices

$${A}_{i}^{j} and {B}_{i}^{j} ;$$

i.e., the LoRA parameters) and γ∈ [symbol] . The initial values of γ can be set close to 0. With such initialization, the values of

$${B}_{i}^{j}$$

do not affect the model performance at the early stage of the training.

While this technology is applicable to a variety of different types of models, for illustration purposes, the following provides a discussion in the context of adapting cross-attention layers (e.g., in diffusion models). For instance, modifying the text-to-image diffusion process through adjustments in cross-attention layers allows for more precise control over the images produced. More specifically, the cross-attention block adjusts the network's latent features based on conditional features, such as text features in text-to-image diffusion models. For given text features c∈ [symbol] and latent image features f∈ [symbol] , a single cross-attention operation includes Q=W^{q}f, K=W^{k}c, V=W^{v}c. The operation then computes a weighted sum over the value features:

$$Attention ( Q , K , V ) = Softmax ( \frac{Q {K}^{T}}{\sqrt{{d}^{′}}} ) V$$

where projection matrices W^{q}, W^{k} and W^{v} map the inputs to a query, key, and value feature, respectively. Here, d′ is the output dimension of key and query features. The output of the attention layer is further transformed using the output linear projection layer parameterized by W^{o}:

Z=W^{o} Attention (Q,K,V)

In some configurations, the training component 118 updates all four matrices, W^{q}, W^{k}, W^{v}, and W^{o} of a cross-attention layer. Formally, let i=1, . . . ,N be the layer number of a model. At layer i, there are four pre-trained matrices

$${W}_{i}^{j} ,$$

j∈{q, k, v, o}. Let r<<min (d, s). The update is constrained by representing the latter with a low-rank decomposition, namely:

$${W}_{i}^{j} + Δ {W}_{i}^{j} = {W}_{i}^{j} + γ {B}_{i}^{j} {A}_{i}^{j}$$

i=1, . . . M j ∈ {q, k, v, o}

After model training, the recontextualization component 120 uses the model components 110 to perform content recontextualization. Given an input content item and recontextualization text, the recontextualization component 120 provides the input content item to the trained hypernetwork model 112, which outputs LoRA parameters. The recontextualization component 120 also provides the input content item and the recontextualization text to the prompt component 114, which provides a prompt by generating a textual description of the input content item and merging the recontextualization text with the textual description of the input content item. The recontextualization component 120 provides a recontextualized content item by providing the prompt as input to the generative model 116 adapted with the LoRA parameters provided by the trained hypernetwork model 112.

In some aspects, the recontextualization component 120 can access additional input that guides the recontextualization. For instance, in the context of image recontextualization in which an image of a clothing item by itself is recontextualized to provide an image of a model wearing the clothing item, an additional input can be pose information regarding a desired pose of the model in the output. The pose information could be, for instance, a textual description of a desired pose or an image providing an indication of the desired pose. As such, the pose information provides pose guidance to cause the generation of a recontextualization image of the model in the specified pose while wearing the item from the input image.

The recontextualization system 104 also includes a user interface component 122 that provides one or more user interfaces for users to interact with the recontextualization system 104. For instance, the user interface component 122 provides one or more user interfaces to user devices, such as the user device 102. In some instances, the user interfaces can be presented on the user device 102 via the application 108, which can be a web browser or a dedicated application for interacting with the recontextualization system 104. Among other things, the user interface component 122 can provide user interfaces for interacting with the recontextualization system 104 to facilitate the recontextualization of content items. For instance, the user interface component 122 can provide user interfaces enabling users to provide input content items and recontextualization text inputs. The user interface component 122 can also provide user interfaces presenting recontextualized content items generated by the recontextualization system 104.

### Example Methods for Content Recontextualization Using Hypernetworks

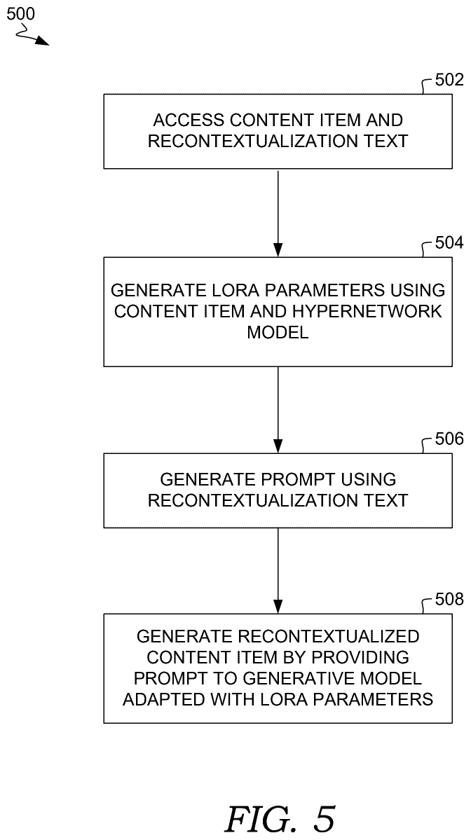

With reference now to FIG. 5, a flow diagram is provided that illustrates a method 500 for content recontextualization using a generative model adapted with hypernetwork-generated LoRA parameters. The method 500 can be performed, for instance, at least in part by the recontextualization system 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, a content item and recontextualization text are accessed for recontextualization. The content item can be any form of media such as text, image, audio, or video, from a storage location or database. The recontextualization text provides a textual description of the new context or setting for recontextualizing the content item. This text can be a description, scenario, or any other form of textual input that specifies how the content item should be adapted or altered. In some aspects, the content item and recontextualization text can be pre-processed for downstream processing, ensuring that they are in a suitable format for the subsequent steps.

LoRA parameters are generated using the content item and a hypernetwork model, as shown at block 504. In this step, the content item is processed by the hypernetwork model, which is configured to predict the parameters for adapting a generative model for recontextualization of the content item. The hypernetwork model takes the content item as input and generates a set of LoRA parameters. These parameters are low-rank matrices that will be used to modify the generative model, allowing it to produce a recontextualized version of the content item. The generation of LoRA parameters by the hypernetwork model can include providing the content item to a content item encoder, which outputs a content item embedding. The content item embedding is then processed by hypernetworks of the hypernetwork model to provide the LoRA parameters.

As shown at block 506, a prompt is also generated using the recontextualization text. In some aspects, a prompt component generates a textual description of the content item, and that textual description is merged with the recontextualization text to provide the prompt. This can involve, for instance, an LLM to analyzing the recontextualization text and the content item to produce a coherent and contextually appropriate prompt. The prompt serves as an instruction for the generative model, guiding it on how to recontextualize the content item.

A recontextualized content item is generated using the prompt and the generative model adapted with the LoRA parameters, as shown at block 508. The generative model, which has been adapted with the LoRA parameters, processes the prompt to produce the recontextualized content item. The type of generative model used can be dependent upon the modality of the content item being recontextualized. The recontextualized content item provides a new version of the content item that fits the context specified by the recontextualization text.

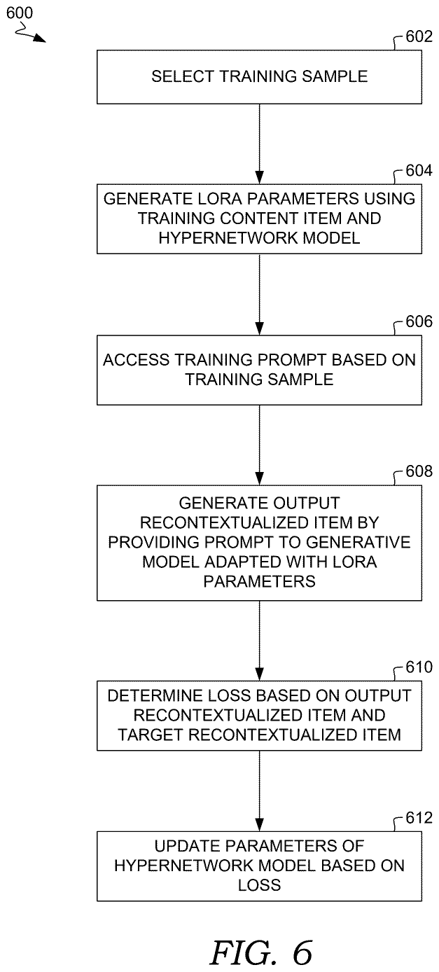

FIG. 6 is a flow diagram showing a method 600 for training a hypernetwork to generate LoRA parameters for adapting a generative model for content recontextualization in accordance with some implementations. The method 600 can be performed, for instance, at least in part by the recontextualization system 104 of FIG. 1. As shown at block 602, a training sample is selected from a training dataset. The training sample includes a training content item and a target recontextualized image. The training sample also includes either a training prompt or a training recontextualization text.

LoRA parameters are generated using the training content item and a trained hypernetwork model, as shown at block 604. The training content item is processed by the hypernetwork model, which is being trained to predict the parameters for adapting a generative model for recontextualization. The hypernetwork model takes the training content item as input and generates a set of LoRA parameters.

As shown at block 606, a training prompt is accessed based on the training sample. In some aspects, the training prompt is included in the training sample. In other aspects in which the training sample includes recontextualization text, the training prompt is provided by generating a textual description of the training content item using a text generation model and merging that textual description with the recontextualization text to provide the training prompt.

As shown at block 608, the generative model is adapted with the LoRA parameters and the adapted model is used to generate an output recontextualized item using the training prompt. The generative model, which has been adapted with the LoRA parameters, processes the training prompt to produce the output recontextualized item. The type of generative model used can vary based on the modality of the content being recontextualized. The output recontextualized item provides a new version of the training content item that fits the context specified by the recontextualization text or the training prompt from the training sample.

A loss is determined at block 610 as a function of the output recontextualized item and the target recontextualized item. In some aspects, this involves comparing the output recontextualized item generated by the generative model with the target recontextualized item from the training sample (with the target recontextualized item serving as ground truth). The loss can be calculated, for instance, as a function of the differences between the output recontextualized item and the target recontextualized item.

As shown at block 612, the parameters of the hypernetwork model are updated (e.g., via backpropagation) based on the loss. The parameters of the hypernetwork model are adjusted to minimize the loss. This typically involves backpropagation, where the gradients of the loss with respect to the hypernetwork model parameters are calculated and used to update the parameters. This iterative process continues until the hypernetwork model is adequately trained to generate accurate LoRA parameters for content recontextualization.

### Exemplary Operating Environment

Having described implementations of the present disclosure, an exemplary operating environment in which embodiments of the present technology may be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing a content item and recontextualization text;
generating Low-Rank Adaptation (LoRA) parameters using the content item and a hypernetwork model;
generating a prompt using the recontextualization text; and
causing a generative model adapted with the LoRA parameters to generate a recontextualized content item using the prompt.

2. The one or more computer storage media of claim 1, wherein the hypernetwork model comprises a content item encoder that generates a content item embedding from the content item, and a plurality of hypernetworks that operate on the content item embedding to provide a plurality of low-rank matrices as the LoRA parameters.

3. The one or more computer storage media of claim 2, where each of the plurality of hypernetworks comprises a shallow neural network having two or fewer hidden layers.

4. The one or more computer storage media of claim 2, wherein the plurality of hypernetworks generate the plurality of low-rank matrices for a plurality of cross-attention matrices of the generative model.

5. The one or more computer storage media of claim 1, wherein generating the prompt using the recontextualization text comprises:
generating a textual description of the content item using a text generation model; and
merging the textual description of the content item with the recontextualization text.

6. The one or more computer storage media of claim 1, wherein the operations further comprise:
accessing a training dataset comprising a plurality of training samples, wherein each training sample comprises a training content item and a target recontextualized item; and
training the hypernetwork model using the training dataset, wherein training the hypernetwork model using a first training sample from the plurality of training samples comprises:
generating a first set of LoRA parameters using a first training content item from the first training sample and the hypernetwork model,
accessing a first training prompt based on the first training sample,
causing the generative model adapted with the first set of LORA parameters to generate a first output recontextualized item using the first training prompt, and
updating parameters of the hypernetwork model based on a loss determined from the first output recontextualized item and a first target recontextualized item from the first training sample.

7. The one or more computer storage media of claim 6, wherein the first training sample comprises the first training prompt.

8. The one or more computer storage media of claim 6, wherein the first training sample comprises a first training recontextualization text and wherein accessing the first training prompt comprises:
generating a textual description of the first training content item using a text generation model; and
merging the textual description of the first training content item with the first training recontextualization text to provide the first training prompt.

9. The one or more computer storage media of claim 6, wherein updating parameters of the hypernetwork model comprises updating parameters of a content item encoder of the hypernetwork model and parameters of a plurality of hypernetworks of the hypernetwork model.

10. A computer-implemented method comprising:
accessing an input image and recontextualization text;
generating Low-Rank Adaptation (LoRA) parameters using the input image and a hypernetwork model;
generating a prompt using the recontextualization text; and
causing a generative model adapted with the LoRA parameters to generate a recontextualized image using the prompt.

11. The computer-implemented method of claim 10, wherein the generative model is a diffusion model.

12. The computer-implemented method of claim 11, wherein the hypernetwork model comprises a plurality of hypernetworks, where the plurality of hypernetworks comprises a separate hypernetwork for each matrix of each cross-attention layer of the diffusion model.

13. The computer-implemented method of claim 12, wherein generating the LoRA parameters comprises:
providing the input image to an image encoder of the hypernetwork model to provide an image embedding; and
providing the image embedding as input to the plurality of hypernetworks to provide the LoRA parameters that comprise a low-rank matrix for each matrix of each cross-attention layer of the diffusion model.

14. The computer-implemented method of claim 10, wherein generating the prompt using the recontextualization text comprises:
generating a textual description of the input image using a text generation model; and
forming the prompt using the textual description of the input image and the recontextualization text, wherein the prompt comprises a textual description of one or more objects in the input image in a context provided by the recontextualization text.

15. The computer-implemented method of claim 10, wherein the method further comprises:
providing the recontextualized image for presentation on a user device.

16. A computer system comprising:
one or more processors; and
one or more computer storage media storing computer-useable instructions that, when used by the one or more processors, cause the one or more processors to perform operations, the operations comprising:
accessing a training dataset comprising a plurality of training samples, wherein each training sample comprises a training content item and a target recontextualized item; and
training a hypernetwork model using the training dataset to provide a trained hypernetwork model that generates LoRA parameters to adapt a generative model for content recontextualization, wherein training the hypernetwork model comprises:
selecting a training sample from the plurality of training samples in the training dataset;
generating a set of LoRA parameters using a training content item from the selected training sample and the hypernetwork model,
accessing a training prompt based on the selected training sample,
causing the generative model adapted with the set of LORA parameters to generate an output recontextualized item using the training prompt, and
updating parameters of the hypernetwork model based on a loss determined from the output recontextualized item and a target recontextualized item from the selected training sample.

17. The computer system of claim 16, wherein the selected training sample comprises the training prompt.

18. The computer system of claim 16, wherein the selected training sample comprises a training recontextualization text and wherein accessing the training prompt comprises:
generating a textual description of the training content item using a text generation model; and
merging the textual description of the training content item with the training recontextualization text to provide the training prompt.

19. The computer system of claim 16, wherein updating parameters of the hypernetwork model comprises updating parameters of a content item encoder of the hypernetwork model and parameters of a plurality of hypernetworks of the hypernetwork model.

20. The computer system of claim 19, wherein parameters of the generative model are frozen when training the hypernetwork model.
